(19) United States
(12) Patent Application Publication
(10) Pub. No.: US 2015/0310663 A1
(43) Pub. Date: Oct. 29, 2015

(54) MEASUREMENT APPARATUS AND METHOD THEREOF

(71) Applicant: CANON KABUSHIKI KAISHA, Tokyo (JP)

(72) Inventors: Masayoshi Yamasaki, Kawasaki-shi (JP); Toshihiro Kobayashi, Tokyo (JP); Tomoaki Higo, Tokyo (JP)

(21) Appl. No.: 14/688,343

(22) Filed: Apr. 16, 2015

(30) Foreign Application Priority Data
Apr. 25, 2014 (JP) 2014-092001

(51) Int. Cl. G06T 17/20; G01B 11/25; H04N 9/31; G06T 7/00; H04N 13/02

(52) U.S. Cl. CPC G06T 17/20; G06T 7/0018; H04N 13/0275; H04N 9/31; G01B 11/2504; G01B 11/2513

(57) ABSTRACT

Images are obtained from an imaging device. The images represent patterns projected in a time series by a projection device. Each pattern comprises dashed lines each of which has a predetermined width. A longitudinal direction of each dashed line is substantially perpendicular to a base line defined by a segment connecting optical centers of the projection and imaging devices. Each dashed line repeats light and dark in the longitudinal direction. The dashed lines are discriminated based on combinations of the light and dark in the images. Correspondences between projected coordinates and image coordinates of the dashed lines are detected based on information regarding the patterns and a discrimination result of the dashed lines. A three-dimensional shape of the object is calculated based on the correspondences, and calibration data of the projection and imaging devices.

### BACKGROUND OF THE INVENTION

1. Field of the Invention

The present invention relates to measurement of the three-dimensional shape of a measurement target object.

2. Description of the Related Art

There is known a three-dimensional measurement apparatus that projects structured light to a measurement target object (to be referred to as a “target object” hereinafter) from a projection unit such as a projector, and obtains the three-dimensional coordinates of the target object by the principle of triangulation based on a position at which an image capturing unit has observed the reflected light. Measurement by such an apparatus requires projection of many patterns and takes a long time.

As a method of shortening the measurement time, there is a method disclosed in Japanese Patent Application No. 63-103375 (literature 1). According to this method, a plurality of slit patterns divided into small segments are simultaneously projected to a target object. The correspondence between the projection pattern and an image obtained by capturing the projection image is obtained. The three-dimensional coordinates of the target object can therefore be obtained quickly.

For a target object made of a material such as plastic, the measurement accuracy may greatly degrade or measurement itself becomes impossible owing to a phenomenon called subsurface scattering or internal scattering. Such a target object needs to undergo a treatment of, for example, coating in advance the surface of the target object with a white powder or the like. This becomes an obstacle that greatly limits the application range of three-dimensional measurement apparatuses.

As a method of suppressing the influence of internal scattering, literature 2 proposes a three-dimensional shape measurement method of modulating slit light by a maximum length sequence (MLS) containing a high-frequency component to reduce the influence of internal scattering.

Literature 2: Tatsuhiko Furuse, Shinsaku Hiura, Kosuke Sato, “More Accurate 3D Scanning Method by Controlling Subsurface Scattering”, MIRU2008 Meeting on Image Recognition and Understanding

When a target object is formed from a material containing a semitransparent portion, high-accuracy measurement is difficult for the method disclosed in literature 1 such that no pattern can be recognized owing to internal scattering or the position of a pattern cannot be accurately specified from a captured image.

In the method proposed in literature 2, slit light is modulated by the MLS, so it is necessary to project patterns equal in number to M multiples of the resolution of the projector in the parallax direction, and capture them by a camera. Although problems such as a decrease in accuracy caused by internal scattering and a measurement failure are solved, the number of projection patterns greatly increases, and a resultant increase in measurement time places a great constraint on practical use.

### SUMMARY OF THE INVENTION

In one aspect, a measurement apparatus for measuring a three-dimensional shape of an object to be measured using a projection device which projects a pattern to measurement space, and an imaging device which captures the measurement space, the apparatus comprising: an obtaining unit configured to obtain a plurality of captured images from the imaging device, wherein the plurality of captured images represent patterns projected in a time series by the projection device, each pattern comprises a plurality of dashed lines each of which has a predetermined width, a longitudinal direction of each dashed line is substantially perpendicular to a base line defined by a line segment connecting an optical center of the projection device and an optical center of the imaging device, and each dashed line repeats light and dark in the longitudinal direction; a discrimination unit configured to discriminate the plurality of dashed lines based on combinations of the light and dark in the plurality of captured images; a coordinate detection unit configured to detect correspondences between projected coordinates of the plurality of dashed lines and image coordinates of the plurality of dashed lines based on information regarding the patterns and a discrimination result of the plurality of dashed lines; and a calculation unit configured to calculate the three-dimensional shape of the object based on the correspondences, and calibration data of the projection device and the imaging device.

According to the aspect, the three-dimensional shape of a measurement target object can be measured quickly by removing the influence of internal scattering of the object including a semitransparent portion by projection of a pattern.

Further features of the present invention will become apparent from the following description of exemplary embodiments with reference to the attached drawings.

### BRIEF DESCRIPTION OF THE DRAWINGS

FIG. 1 is a block diagram showing the arrangement of a three-dimensional measurement apparatus according to an embodiment.

FIG. 2 is a block diagram for explaining the function of an information processing apparatus according to the first embodiment.

FIG. 3 is a view showing an example of a basic coordinate detection pattern image.

FIG. 4 is a view showing a part extracted from dashed lines constituting the basic coordinate detection pattern image.

FIG. 5 is a view showing an example of changing the projection order of a pattern in which the dashed lines shown in FIG. 4 are shifted.

FIG. 6 is a flowchart for explaining measurement processing by the three-dimensional measurement apparatus according to the first embodiment.

FIGS. 7A and 7B are views showing gray codes as examples of a space division pattern.

FIG. 8 is a view showing an example of a divided region coordinate detection pattern image.

FIG. 9 is a flowchart for explaining measurement processing by a three-dimensional measurement apparatus according to the second embodiment.

FIG. 10 is a block diagram for explaining the function of an information processing apparatus according to the third embodiment.

FIG. 11 is a flowchart for explaining measurement processing by a three-dimensional measurement apparatus according to the third embodiment.

FIG. 12 is a view showing an example of patterns generated by a projection pattern generation unit according to the fourth embodiment.

FIG. 13 is a view showing projection patterns generated by arranging the patterns shown in FIG. 12 in the spatial direction.

FIG. 14 is a flowchart for explaining measurement processing by a three-dimensional measurement apparatus according to the fourth embodiment.

FIG. 15 is a flowchart for explaining measurement processing by a three-dimensional measurement apparatus according to the fifth embodiment.

### DESCRIPTION OF THE EMBODIMENTS

Measurement and information processing according to embodiments of the present invention will now be described in detail with reference to the accompanying drawings. Note that an arrangement described in the following embodiment is merely an example, and the present invention is not limited to the illustrated arrangement.

### First Embodiment

A three-dimensional measurement apparatus described in an embodiment projects, to a measurement target object, structured light (to be referred to as “pattern light” hereinafter) having patterns in which the light and dark of a plurality of dashed lines are temporally changed. The respective dashed lines are discriminated in images obtained by capturing the series of projection images, and the influence of internal scattering generated in the measurement target object is removed, thereby quickly measuring the high-accuracy three-dimensional coordinates (three-dimensional shape) of the surface of the object.

[Apparatus Arrangement]

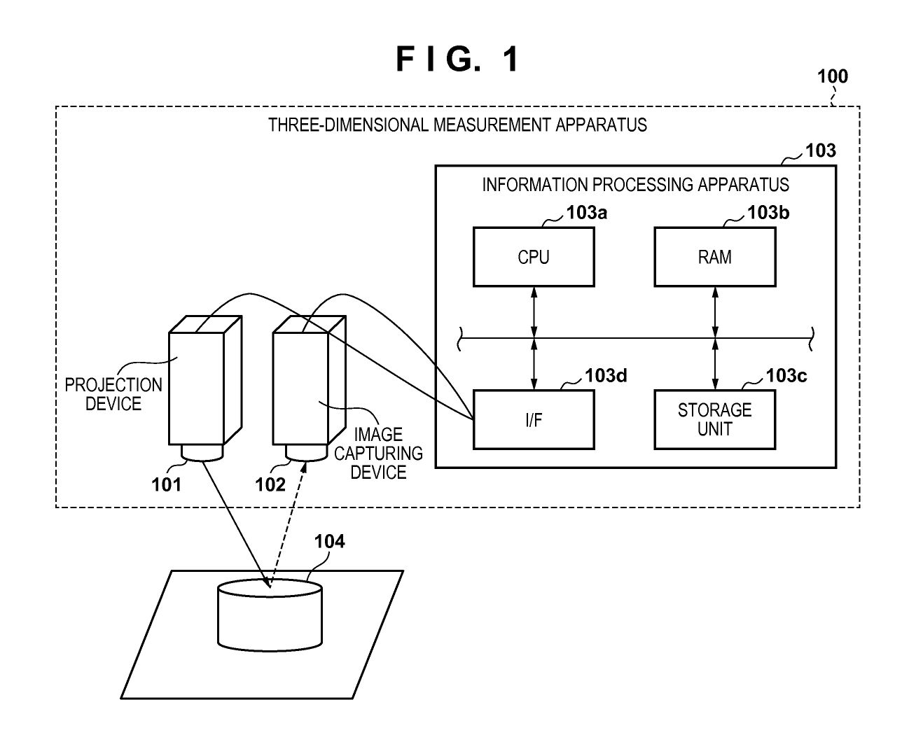

The arrangement of a three-dimensional measurement apparatus 100 according to the embodiment is shown in the block diagram of FIG. 1.

A projection device 101 projects pattern light (to be described later) to a measurement target object (to be referred to as a “target object” hereinafter) 104. The pattern light is reflected by the surface of the target object 104, and an image of the target object 104 is captured by an image capturing device 102. The image captured by the image capturing device 102 is sent to an information processing apparatus 103, and the information processing apparatus 103 calculates the three-dimensional coordinates of the target object 104. Also, the information processing apparatus 103 controls the operations of the projection device 101 and image capturing device 102.

The information processing apparatus 103 is a computer device. A microprocessor (CPU) 103a of the information processing apparatus 103 executes a measurement processing program stored in a storage unit 103c serving as a nonvolatile memory, using a random access memory (RAM) 103b as a work memory, and controls the operations of the projection device 101 and image capturing device 102 through an interface (I/F) 103d, thereby implementing the function of the information processing apparatus 103 (to be described later).

Information Processing Apparatus

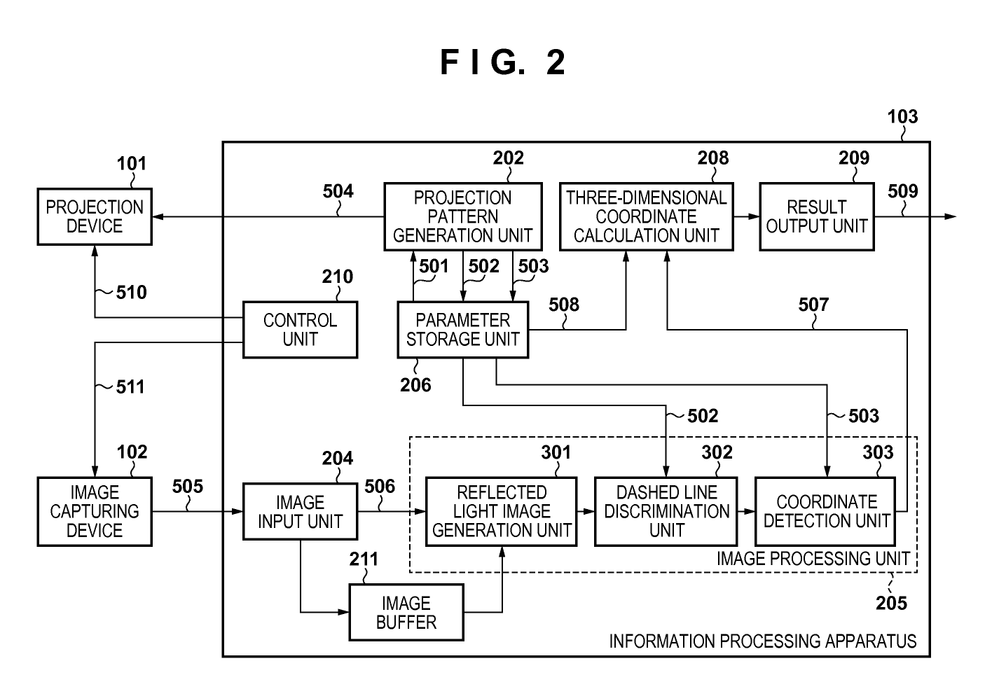

The function of the information processing apparatus 103 according to the first embodiment will be explained with reference to the block diagram of FIG. 2. A control unit 210 controls the operation of each unit of the information processing apparatus 103 (to be described later), and controls the operations of the projection device 101 and image capturing device 102.

A projection pattern generation unit 202 properly generates a pattern image 504 such as a basic pattern image (to be referred to as a “basic coordinate detection pattern image” hereinafter) for detecting coordinates based on dashed line information 501 that is read out from a parameter storage unit 206 and represents the cycle of the dashed line. The projection pattern generation unit 202 outputs the pattern image 504 to the projection device 101. The projection pattern generation unit 202 generates dashed line code information 502 and projection pattern information 503, and stores them in the parameter storage unit 206. Note that the cycle of the dashed line is equivalent to one repetition in repetitions of the white line portion (light portion) and black line portion (dark portion) of the dashed line, and is the sum of the number of pixels of the light portion and the number of pixels of the dark portion in one repetition.

The parameter storage unit 206 is allocated in the RAM 103b, the storage unit 103c, or the like, and holds various parameters necessary for three-dimensional measurement. The parameters include settings for controlling the projection device 101 and the image capturing device 102, calibration data 508, and the like. In addition, the parameter storage unit 206 holds the dashed line information 501 representing the frequency (or cycle) of the dashed line that is defined by a user, the dashed line code information 502 and projection pattern information 503 that are generated by the projection pattern generation unit 202, and the like.

The projection device 101 projects pattern light based on the pattern image 504 to the target object 104. Note that the projection of pattern light starts when the projection device 101 receives a projection control signal 510 output from the control unit 210.

The pattern image 504 generated by the projection pattern generation unit 202 can be stored in, for example, the parameter storage unit 206 allocated in the storage unit 103c serving as a nonvolatile memory such as a hard disk drive or a solid state drive. In this case, the dashed line information 501, the dashed line code information 502, the projection pattern information 503, and the like are associated with the stored pattern image 504. When the pattern image 504 is stored in the parameter storage unit 206 or the like, the projection pattern generation unit 202 can obtain the pattern image 504 from the parameter storage unit 206 or the like, and output it to the projection device 101.

Basic Coordinate Detection Pattern Image

A basic coordinate detection pattern image projected as pattern light is constituted by dashed lines capable of removing the influence of internal scattering in the target object 104 along with pattern projection by the projection device 101. The longitudinal direction of each pattern is almost perpendicular to a baseline defined by a line segment connecting the optical center of the projection device 101 and the optical center of the image capturing device 102, and includes a plurality of dashed lines each of a predetermined width that repeat the light and dark in the longitudinal direction. In other words, the basic coordinate detection pattern is a pattern configured to project the plurality of dashed lines, and the basic coordinate detection pattern image aims to quickly detect the three-dimensional coordinates of the target object 104 at high accuracy.

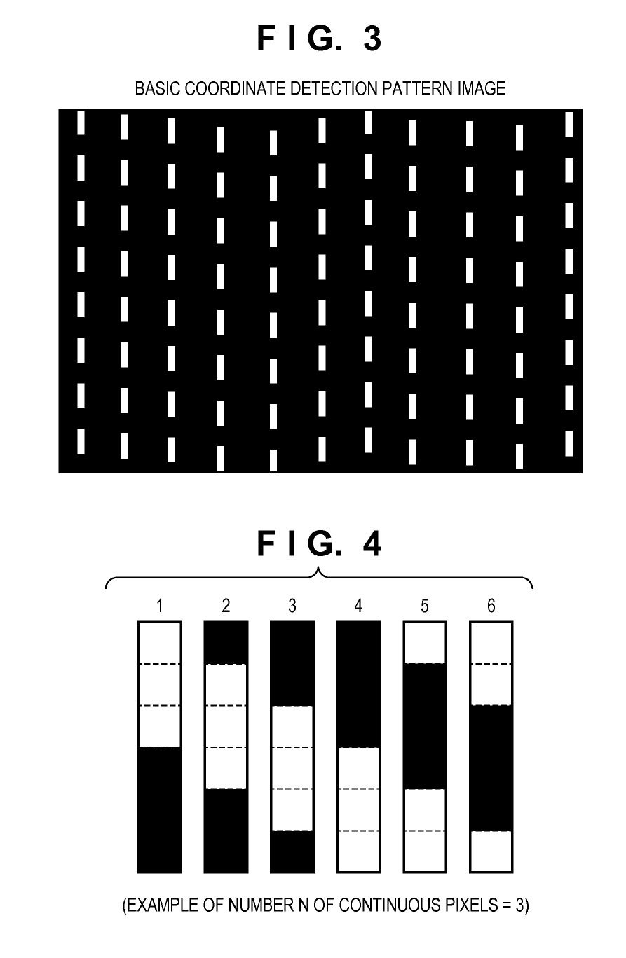

FIG. 3 shows an example of the basic coordinate detection pattern image. As shown in FIG. 3, the basic coordinate detection pattern image is formed from a plurality of dashed lines, and a plurality of dashed lines are simultaneously projected on the target object 104 by one pattern projection. The internal scattering component of the target object 104 can be removed from images obtained by capturing the projection images of respective dashed line patterns.

In removal of the internal scattering component, first, a plurality of images are captured, in which patterns prepared by sequentially shifting a dashed line pattern of one cycle repeating light and dark in a predetermined cycle (repeating the white and black line portions in a predetermined cycle) (that is, dashed line patterns different in only phase) are projected. Then, luminance values are compared in the time direction (time series) at each pixel in the plurality of captured images, thereby removing internal scattering components from the images. Details of this method will be described later.

In order to remove internal scattering components from captured images, the projection pattern generation unit 202 needs to generate a plurality of patterns by the total number of phase shift amounts so as to shift the phase of the dashed line by one cycle. However, the captured images of the projection images of these patterns suffice to include all dashed lines, the phases of which are shifted by one cycle. The order of the phase shift is not a problem in removal of the internal scattering component.

In the first embodiment, the projection order is defined so that the change order of the phase shift amount becomes unique to each dashed line. Even if these dashed lines are simultaneously projected, they can be discriminated from a plurality of captured images. Since all dashed lines completely cover phases of one cycle, internal scattering components can be removed from captured images. By simultaneously projecting a plurality of dashed lines instead of projecting dashed lines one by one, the total number of projection patterns for removing the internal scattering component can be reduced. As a result, quick three-dimensional measurement can be implemented while suppressing the influence of internal scattering.

In each dashed line of the basic coordinate detection pattern image shown in FIG. 3, the number of pixels constituting the light portion and the number of pixels constituting the dark portion are equal (the length of the light portion and the length of the dark portion are equal), and the light portion and the dark portion are repeated regularly. Letting N be the number of pixels (to be referred to as “continuous pixels” hereinafter) that continue at each of the light and dark portions of the dashed line, all phases of one cycle of the dashed line can be described by shifting the dashed line 2N times pixel by pixel in the longitudinal direction.

In order to remove the internal scattering component, the projection pattern generation unit 202 generates the pattern image 504 in which all dashed lines are sequentially shifted in the longitudinal direction in time series, and outputs the pattern image 504 to the projection device 101. FIG. 4 shows a part extracted from dashed lines constituting the basic coordinate detection pattern image (the number N of continuous pixels=3). FIG. 4 shows a total of six types of patterns shifted pixel by pixel for one cycle.

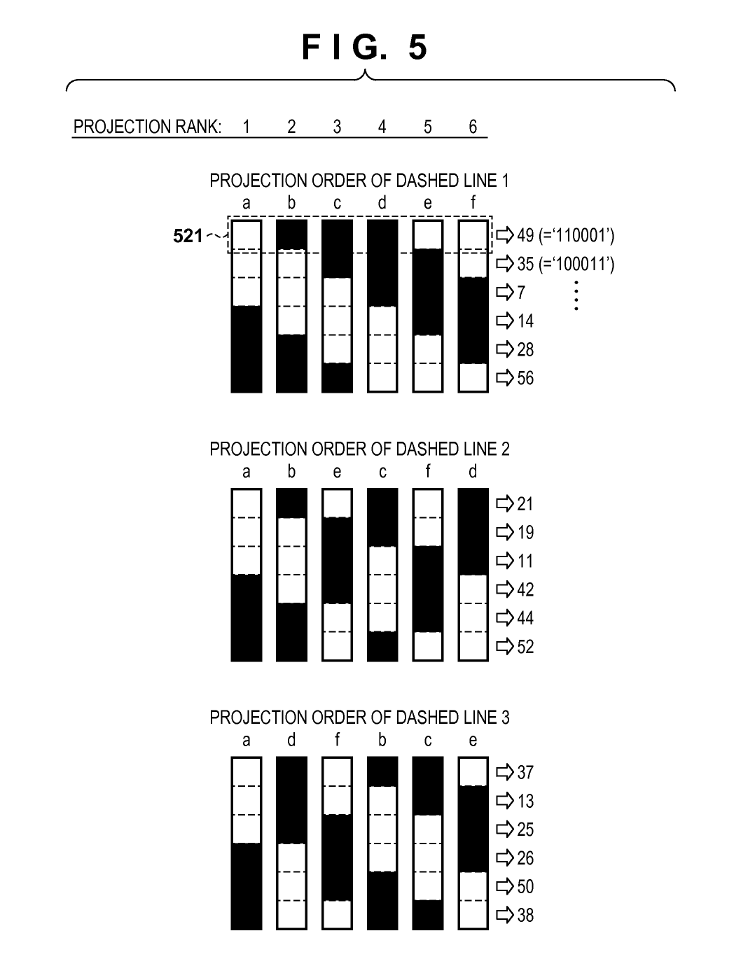

To discriminate each dashed line shown in FIG. 3 from a captured image, the order of projection is changed for each dashed line in a pattern in which dashed lines are shifted. FIG. 5 shows an example of changing the projection order of a pattern in which the dashed lines shown in FIG. 4 are shifted. FIG. 5 shows three types of dashed lines (dashed lines 1 to 3). Each of dashed lines 1 to 3 includes all phases of one cycle on 2N (2×3=6) captured images of the projection images of the patterns. Dashed lines 1 to 3 have different projection orders. For this reason, even when dashed lines 1 to 3 are simultaneously projected, the respective dashed lines can be discriminated.

That is, the three types of dashed lines shown in FIG. 5 can be handled as identical dashed lines on six captured images of the projection images of the patterns. In addition, the projection order is different between the respective dashed lines, and changes of light and dark are not coincident between the pixels of the dashed lines. Hence, by projecting these dashed lines sequentially from left in time series, the respective dashed lines can be discriminated from an image in which the three types of dashed lines are simultaneously projected.

When dashed lines with the number N of continuous pixels=3 are shifted for one cycle, six basic coordinate detection pattern images are sequentially projected. In this case, there are 20 combinations of changes of light and dark of a pixel of interest in captured images in the time direction. Six combinations of light and dark are required to uniquely discriminate one of these dashed lines. In this example, up to three dashed lines can be discriminated. Generally, there are _{2N}C_{N} combinations of light and dark. Three dashed lines can be discriminated for N=3 as in the above example, and seven dashed lines can be discriminated for N=4. In other words, the number of discriminable dashed lines depends on the cycle 2N of the dashed line.

The projection interval of the dashed line is indicated by (the number of pixels of the projection device 101)÷(the number of projections) pixels. The projection pattern generation unit 202 generates the dashed line code information 502 based on the combination of light and dark. The projection pattern generation unit 202 outputs, as the projection pattern information 503 together with the dashed line code information 502 to the parameter storage unit 206, information representing the projection position of each dashed line in the projection pattern.

The example in which the light and dark portions are repeated regularly in every N pixels has been described above. However, the number of pixels of the light portion and the number of pixels of the dark portion may be different, or the light and dark portions may not be repeated regularly. Multiple tones may be used instead of the binary of the light and dark portions, or encoding may be performed by the projection color.

Information Processing Apparatus (Continued)

At the timing when the image capturing device 102 receives an image capturing control signal 511 output from the control unit 210, the image capturing device 102 captures an image at predesignated image capturing parameters (shutter speed, f-number, and subject distance), and outputs a captured image 505 to an image input unit 204.

The image input unit 204 stores the image received from the image capturing device 102 in an image buffer 211. Since a plurality of images are captured by irradiating the target object 104 with different pattern beams, the image input unit 204 sequentially receives the images from the image capturing device 102 and adds the received images to the image buffer 211. Upon receiving a necessary number of images for one three-dimensional coordinate calculation, the image input unit 204 outputs, to an image processing unit 205, information 506 representing captured images held in the image buffer 211.

Upon receiving the information 506 representing captured images, the image processing unit 205 performs, on the captured images, image processing necessary before calculating three-dimensional coordinates. The image processing unit 205 includes a reflected light image generation unit 301 that calculates a directly reflected light component in an image, a dashed line discrimination unit 302 that discriminates each dashed line in the projection area of the projection device 101, and a coordinate detection unit 303 that associates projection coordinates and image coordinates.

The reflected light image generation unit 301 calculates a directly reflected light component from the maximum and minimum values of a pixel value obtained by observing the pixel value in the time direction for each pixel in images obtained by capturing the projection images of dashed line patterns of one cycle. More specifically, at a measurement target point on the target object 104 in a captured image, no pattern light is projected to a pixel corresponding to the dark portion at the time of projecting a dashed line pattern, no directly reflected light component is observed from this pixel, and only the internal scattering component is observed. To the contrary, pattern light is projected to a pixel corresponding to the light portion at the time of projecting a dashed line pattern, so both the directly reflected light component and the internal scattering component are observed from this pixel.

The value of a pixel corresponding to the dark portion can be regarded as the internal scattering component itself on condition that the frequency of the dashed line is sufficiently high. A value obtained by subtracting the pixel value of the dark portion from the pixel value of the light portion can be regarded as a directly reflected light component reflected by the surface of the target object 104. In this embodiment, therefore, the minimum value of each pixel of a captured image in the time direction is handled as the internal scattering component, and a value obtained by subtracting the minimum value of each pixel from the maximum value is handled as the directly reflected light component. See literature 3 for details of calculation of the directly reflected light component.

Literature 3: S. K. Nayar, G. Krishnan, M. D. Grossberg, R. Raskar, “Fast Separation of Direct and Global Components of a Scene using High Frequency Illumination”, ACM2006

The reflected light image generation unit 301 removes internal scattering components from a series of captured images by the above-described processing, and generates a series of images (to be referred to as “directly reflected light images” hereinafter) containing only directly reflected light components. In processing of obtaining the directly reflected light component, all pixels can be similarly processed regardless of projection of the dashed line pattern because the time-series luminance change is small in a pixel in which no dashed line pattern is projected, and the difference between the maximum and minimum values is small.

The dashed line discrimination unit 302 performs discrimination of each dashed line in the directly reflected light image by referring to the dashed line code information 502 stored in the parameter storage unit 206. Attention is paid to an arbitrary pixel, ‘1’ is set as the pixel value of the light portion in the directly reflected light image, and ‘0’ is set as the pixel value of the dark portion. When pixel values are arranged in the projection order of the pattern, each segment 521 of the dashed line can be expressed by a binary number such as ‘100011’. Since the projection order of the pattern in which each dashed line is shifted is different for each dashed line, as shown in FIG. 5, a unique binary number is decoded for each segment 521 of the dashed line.

In the example shown in FIG. 5, ‘110001’ (=49) is decoded as the decoding result of the first segment 521 of dashed line 1, and ‘100011’ (=35) is decoded as the decoding result of the second segment 521. Similar decoding results are obtained even for the third and subsequent segments 521 of dashed line 1 and the respective segments 521 of dashed lines 2 and 3. The segment 521 of the dashed line is specified based on the decoding result. By specifying all the segments 521, each dashed line can be discriminated. In FIG. 5, the value of a pixel of projection rank 1 on each dashed line is arranged at the least significant bit (LSB), and the value of a pixel of projection rank 6 is arranged at the most significant bit (MSB).

The coordinate detection unit 303 determines the coordinates of a coordinate detection pattern based on the projection pattern information 503 stored in the parameter storage unit 206 and the discrimination result of the dashed line discrimination unit 302. By this processing, in a captured image in which a dashed line has been detected, projection coordinates corresponding to a light component directly reflected from the dashed line are uniquely determined. Since the projection coordinates of the dashed line are known, the correspondences between the projection coordinates of the dashed line and the image coordinates of the directly reflected light component of the dashed line in the captured image are detected. The coordinate detection unit 303 outputs, to a three-dimensional coordinate calculation unit 208, coordinate information 507 representing the correspondences between the projection coordinates and the image coordinates.

The three-dimensional coordinate calculation unit 208 calculates three-dimensional coordinates 509 of the target object 104 from the coordinate information 507 by referring to the calibration data 508 of the projection device 101 and image capturing device 102 that is stored in the parameter storage unit 206. A result output unit 209 outputs the three-dimensional coordinates 509 of the target object 104 that have been calculated by the three-dimensional coordinate calculation unit 208. The result output unit 209 is an interface for a USB (Universal Serial Bus), HDMI® (High-Definition Multimedia Interface), and a wired or wireless network. Output destinations of the three-dimensional coordinates 509 are, for example, a monitor, another computer or server apparatus, an auxiliary storage device, and various recording media.

[Measurement Processing]

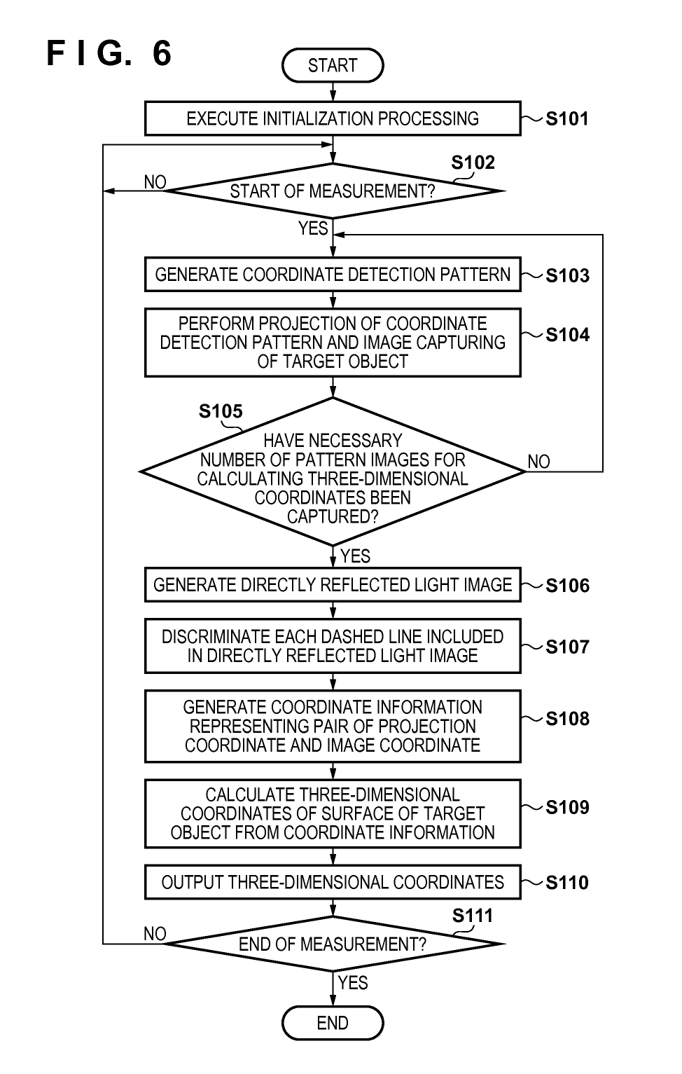

Measurement processing by the three-dimensional measurement apparatus 100 according to the first embodiment will be explained with reference to the flowchart of FIG. 6.

When the three-dimensional measurement apparatus 100 is activated, the control unit 210 executes initialization processing (S101), and waits for input of a measurement start user instruction (S102). The initialization processing includes, for example, activation of the projection device 101 and image capturing device 102, and processing of loading various parameters such as calibration data of the projection device 101 and image capturing device 102 from the storage unit 103c to the parameter storage unit 206.

If the measurement start user instruction is input, the control unit 210 controls the projection pattern generation unit 202 to generate a coordinate detection pattern, and output the pattern image 504 representing the coordinate detection pattern to the projection device 101 (S103). When the pattern image 504 is stored in the parameter storage unit 206 or the like, the projection pattern generation unit 202 can also output the pattern image 504 stored in the parameter storage unit 206 or the like to the projection device 101.

The control unit 210 outputs the projection control signal 510 and controls the projection device 101 to project the coordinate detection pattern to the target object 104. In addition, the control unit 210 outputs the image capturing control signal 511 and controls the image capturing device 102 to capture an image of the target object 104 to which pattern light has been projected (S104). Steps S103 and S104 are repeated until it is determined in step S105 that a necessary number of pattern images for calculating three-dimensional coordinates have been captured and these images have been input to the image input unit 204.

Upon completion of capturing the necessary number of pattern images for calculating three-dimensional coordinates, the reflected light image generation unit 301 generates a directly reflected light image from the images of the target object 104 on which the coordinate detection patterns have been projected (S106). Subsequently, the dashed line discrimination unit 302 discriminates each dashed line included in the directly reflected light image based on the dashed line code information 502 (S107). Based on the discrimination result of each dashed line and the projection pattern information 503, the coordinate detection unit 303 generates the coordinate information 507 representing a pair of projection coordinates and image coordinates (S108).

The three-dimensional coordinate calculation unit 208 calculates the three-dimensional coordinates 509 of the surface of the target object 104 from the coordinate information 507 (S109). The control unit 210 outputs the calculated three-dimensional coordinates 509 to a preset output destination through the result output unit 209 (S110), and determines a user instruction (S111) to return the process to step S102 or end the three-dimensional measurement processing.

Note that the processes in steps S104 to S109 need not be executed in the order shown in FIG. 6. The order of processes including no dependence may be properly changed, or such processes can also be processed in parallel.

As described above, patterns each including a plurality of dashed lines are projected by the projection device 101, and each dashed line is discriminated. Accordingly, the influence of internal scattering generated in the target object 104 can be removed to quickly calculate three-dimensional coordinates at high accuracy.

### Second Embodiment

Information processing according to the second embodiment of the present invention will be described below. In the second embodiment, the same reference numerals as those in the first embodiment denote the same parts, and a detailed description thereof will not be repeated.

In the second embodiment, a projection device 101 projects a space division pattern to divide a space including a target object 104 into a plurality of regions. Further, the projection device 101 projects, in the divided regions, coordinate detection patterns including a plurality of uniquely discriminable dashed lines. While removing the influence of internal scattering generated in the target object 104, the three-dimensional coordinates of the surface of the target object 104 are measured quickly at high accuracy. In the second embodiment, it is possible to project a larger number of dashed lines than those in the first embodiment and discriminate these dashed lines, implementing higher-speed measurement.

A projection pattern generation unit 202 generates a space division pattern and a divided region coordinate detection pattern, and outputs a pattern image 504 of them to the projection device 101. Also, the projection pattern generation unit 202 generates space division code information in addition to dashed line code information 502 and projection pattern information 503, and stores these pieces of information in a parameter storage unit 206.

The space division pattern is a pattern which can be projected by the projection device 101 and is used to divide a space (to be referred to as a “measurement space” hereinafter) including the target object 104 into a plurality of regions. The divided region coordinate detection pattern is a pattern constituted to include a predetermined number of dashed lines in each region (to be referred to as a “divided region” hereinafter) divided by the space division pattern. By combining the space division pattern and the divided region coordinate detection pattern, the influence of internal scattering can be removed to calculate projection coordinates at high accuracy more quickly than in the first embodiment.

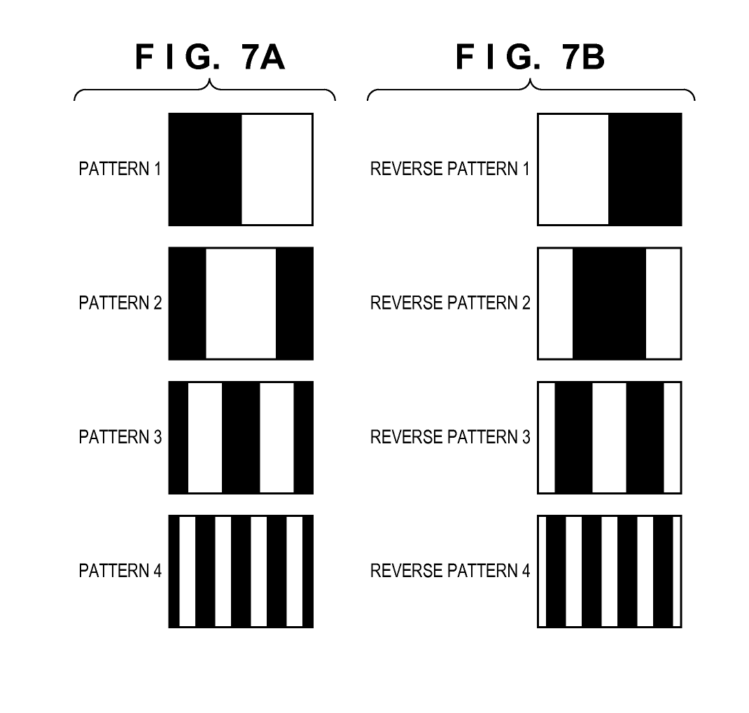

The space division pattern is arbitrary as long as the entire measurement space can be divided into a predetermined number of regions. FIGS. 7A and 7B show gray codes as examples of the space division pattern.

The projection device 101 sequentially projects the gray codes shown in FIG. 7A as the space division pattern to the measurement space, and an image capturing device 102 captures images corresponding to the projection patterns. There are 16 combinations of light and dark in captured images by projection of the gray codes of four patterns shown in FIG. 7A. Thus, the projection device 101 can divide the measurement space into 16 regions, and can determine a region to which each pixel in the captured image belongs.

In addition to the patterns shown in FIG. 7A, patterns in FIG. 7B obtained by reversing these patterns are used to suppress the influence of the reflectance of a measurement target at the time of space division, and stably read a combination of light and dark in a captured image.

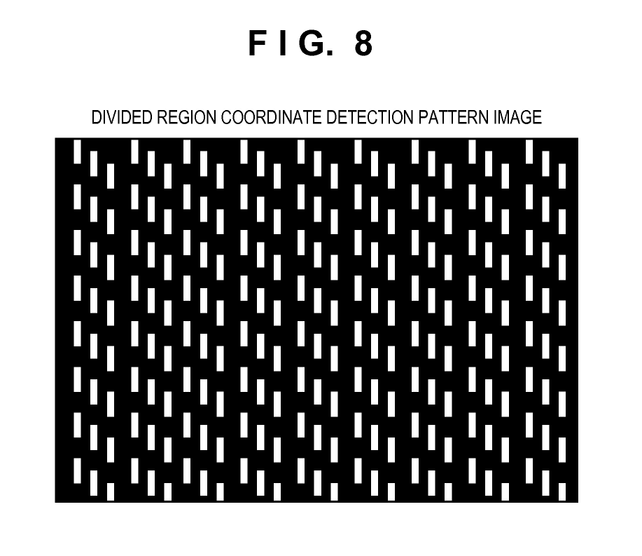

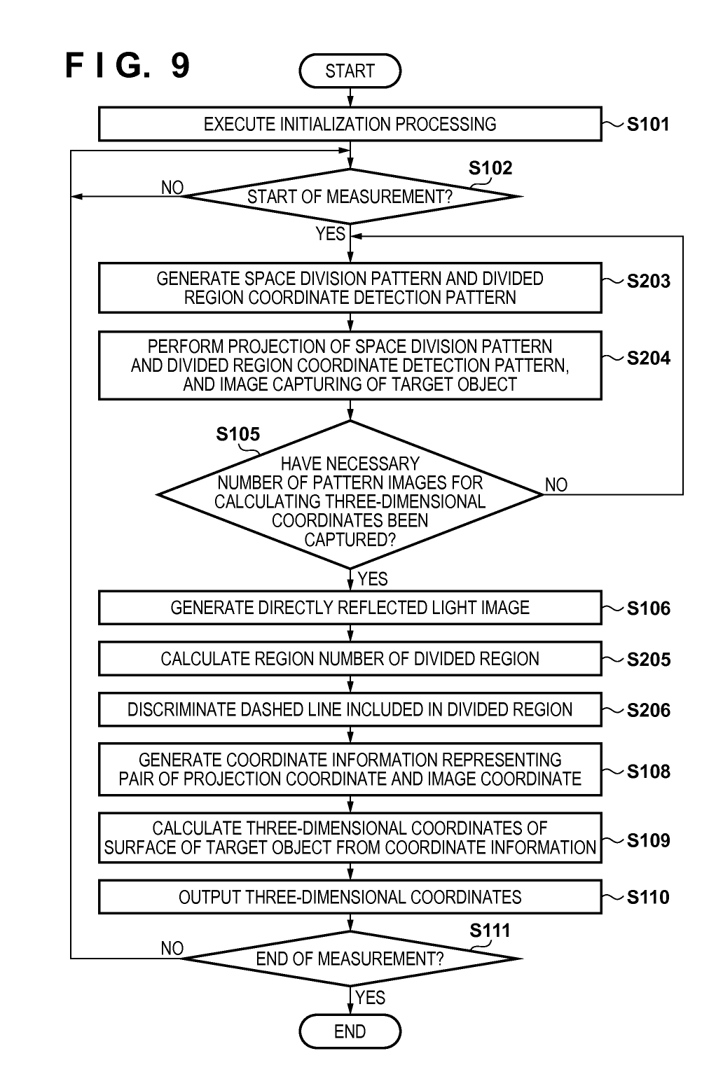

FIG. 8 shows an example of a divided region coordinate detection pattern image. The divided region coordinate detection pattern image aims to uniquely discriminate a plurality of dashed lines in each region divided by the space division pattern, and is a pattern in which a plurality of dashed lines are arranged at equal intervals in this region. In other words, the divided region coordinate detection pattern image is a pattern in which a plurality of dashed lines are arranged at a pixel interval obtained by dividing the width of the divided region by the number of projections.

The number of dashed lines arranged in each region is determined by the width of the divided region (pixel width obtained by dividing the number of pixels of the projection device 101 by the number of divided regions), and a maximum discrimination count described in the first embodiment. In order to discriminate each dashed line in each region, a pattern is generated, in which the projection order is defined so that the change order of the phase shift amount becomes unique to each dashed line.

A dashed line discrimination unit 302 performs processing of dividing the measurement space into regions based on a combination of light and dark of images obtained by capturing the measurement space in which the space division pattern has been projected. The dashed line discrimination unit 302 discriminates each dashed line in a directly reflected light image by referring to the dashed line code information 502 stored in the parameter storage unit 206. Note that the dashed line discrimination unit 302 according to the second embodiment discriminates a dashed line not for the entire image but for each divided region, unlike the first embodiment. The position of a dashed line in the entire image is specified by a combination of the discriminated dashed line and a region to which the dashed line belongs.

Measurement processing by a three-dimensional measurement apparatus 100 according to the second embodiment will be explained with reference to the flowchart of FIG. 9. In FIG. 9, the same reference numerals as those shown in FIG. 6 denote the same processes, and a detailed description thereof will not be repeated.

If a measurement start user instruction is input, a control unit 210 controls the projection pattern generation unit 202 to generate a space division pattern and a divided region coordinate detection pattern, and output the pattern image 504 representing these patterns to the projection device 101 (S203).

The control unit 210 outputs a projection control signal 510 to the projection device 101 to project the space division pattern and the divided region coordinate detection pattern to the measurement space. In addition, the control unit 210 outputs an image capturing control signal 511 and controls the image capturing device 102 to capture an image of the measurement space in which pattern light has been projected (S204). As in the first embodiment, steps S203 and S204 are repeated until a necessary number of pattern images for calculating three-dimensional coordinates are captured and these images are input to an image input unit 204.

Upon completion of capturing the necessary number of pattern images for calculating three-dimensional coordinates, generation (S106) of a directly reflected light image is executed. After that, the dashed line discrimination unit 302 calculates the region number of each divided region from the directly reflected light image by referring to space division code information stored in the parameter storage unit 206 (S205), and discriminates a dashed line for each divided region by referring to the dashed line code information 502 (S206).

Thereafter, generation (S108) of coordinate information 507, calculation (S109) of three-dimensional coordinates 509, and output (S110) of the three-dimensional coordinates 509 are performed as in the first embodiment. In accordance with a user instruction, the process returns to step S102, or the three-dimensional measurement processing ends.

In this manner, a pattern including a plurality of discriminable dashed lines is projected to each space-divided region by the projection device 101, and a dashed line is discriminated in each region. As a result, the influence of internal scattering generated in the target object 104 can be removed to calculate three-dimensional coordinates at high accuracy more quickly.

### Third Embodiment

Information processing according to the third embodiment of the present invention will be described below. In the third embodiment, the same reference numerals as those in the first and second embodiments denote the same parts, and a detailed description thereof will not be repeated.

In the third embodiment, a plurality of dashed lines are continuously projected to line regions in time series. The third embodiment will explain an example in which the respective line regions are discriminated (dashed lines are discriminated) in images obtained by capturing the projection images, and the influence of internal scattering generated in a measurement target is removed, thereby precisely measuring three-dimensional coordinates on the surface of the measurement target.

[Apparatus Arrangement]

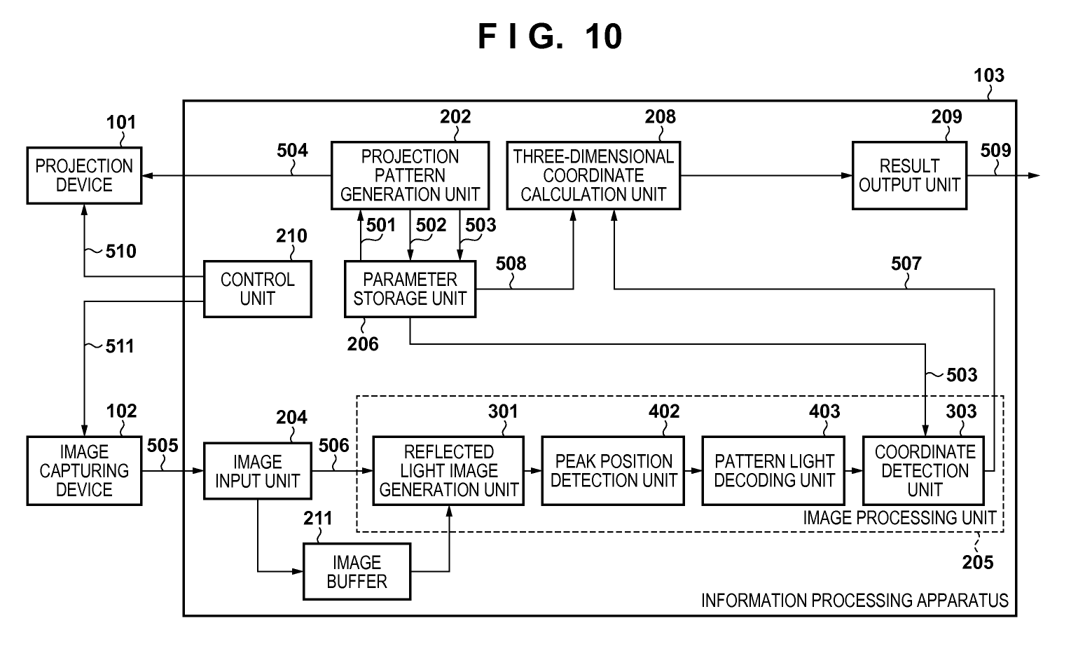

The function of an information processing apparatus 103 according to the third embodiment will be explained with reference to the block diagram of FIG. 10. The information processing apparatus 103 according to the third embodiment is different from the arrangement of FIG. 2 in the internal arrangement of an image processing unit 205.

Upon receiving information 506 representing captured images, the image processing unit 205 performs, on the captured images, image processing necessary before calculating three-dimensional coordinates. The image processing unit 205 includes a reflected light image generation unit 301, a peak position detection unit 402, a pattern light decoding unit 403, and a coordinate detection unit 303. The processes of the reflected light image generation unit 301 and coordinate detection unit 303 are the same as those in the first embodiment, and a detailed description thereof will not be repeated.

The peak position detection unit 402 detects, from a directly reflected light image, the peak position of the luminance (pixel value) of a line region (which is a solid line on the directly reflected light image) where dashed lines have been projected. Although the correspondence between a captured image and a projection image needs to be obtained in order to obtain the three-dimensional position of a measurement target point, a peak position exists at the coordinates of the measurement target point on the captured image. As a peak position detection method, for example, smoothing and numerical differentiation is used. When the peak position detection unit 402 uses the directly reflected light image, the coordinates on the captured image can be obtained at high accuracy.

The pattern light decoding unit 403 discriminates a dashed line corresponding to a pixel at the peak position. When the light and dark of a segment 521 of the dashed line are indicated by ‘1’ and ‘0’, as shown in FIG. 5, a decoding result (for example, 49=‘110001’) shown in FIG. 5 is obtained, and this decoding result will be referred to as a “dashed line discrimination number”. For example, for a repetition of light, dark, dark, light, light, and dark, the dashed line discrimination number is ‘011001’ (=25) and indicates the third segment of dashed line 3. By performing this processing on six time-series images, a dashed line discrimination number unique to each dashed line is decoded and the dashed line can be discriminated because the projection order of the pattern is different for each dashed line, as shown in FIG. 5.

[Measurement Processing]

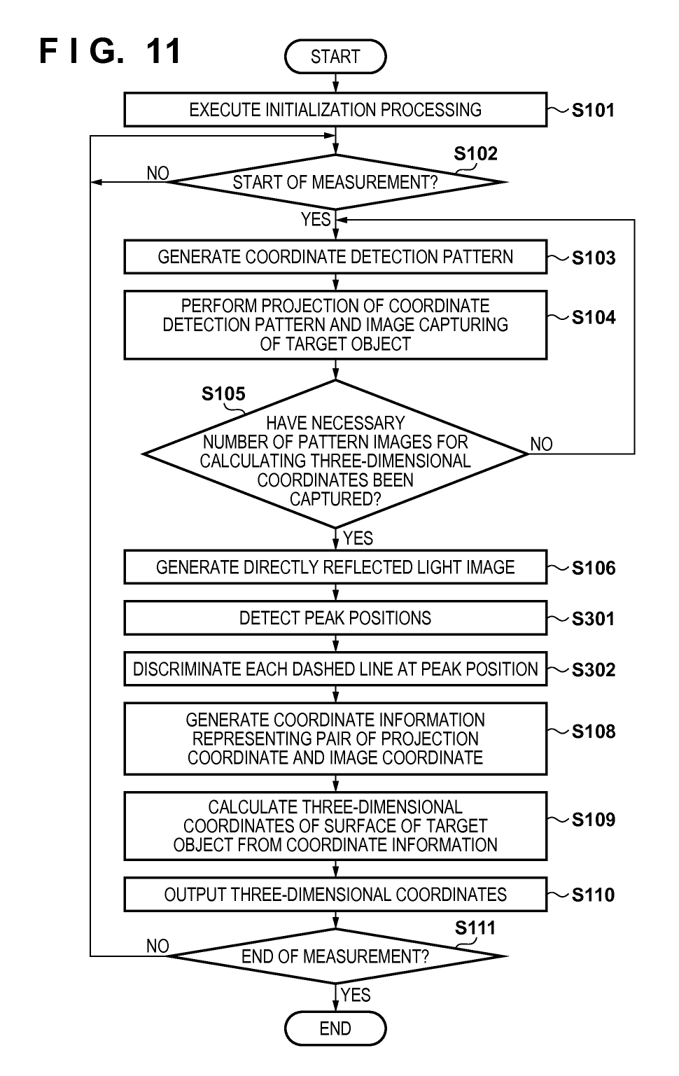

Measurement processing by a three-dimensional measurement apparatus 100 according to the third embodiment will be explained with reference to the flowchart of FIG. 11. Processes in steps S101 to S106 are the same as the processes in the first embodiment shown in FIG. 6, and a detailed description thereof will not be repeated.

If a directly reflected light image is generated, the peak position detection unit 402 detects the peak position of a line region where each dashed line has been projected based on the directly reflected light image (S301). By detecting in advance the peak position on the captured image that is used as a measurement target point, subsequent dashed line discrimination processing can be limited to the peak position. Then, the pattern light decoding unit 403 discriminates each dashed line at the peak position (S302).

Processes in subsequent steps S108 to S111 are the same as those in the first embodiment shown in FIG. 6, and a detailed description thereof will not be repeated.

In this fashion, a coordinate detection pattern capable of calculating directly reflected light is projected, directly reflected light of a target object 104 is calculated, and the three-dimensional shape of the target object 104 is measured based on the directly reflected light. By removing an indirect light component such as internal scattering, three-dimensional coordinates can be calculated precisely. This is effective when the target object 104 includes a semitransparent portion that causes internal scattering.

### Fourth Embodiment

Information processing according to the fourth embodiment of the present invention will be described below. In the fourth embodiment, the same reference numerals as those in the first to third embodiments denote the same parts, and a detailed description thereof will not be repeated.

The fourth embodiment will explain an example in which the number of simultaneously discriminable line regions is increased by changing the order of the projection areas and non-projection areas of dashed lines in time series for each line region and projecting the dashed lines. Also, the fourth embodiment will explain an example in which each line region is discriminated in an image obtained by capturing the projection image, and the influence of internal scattering generated in a measurement target is removed, thereby precisely measuring three-dimensional coordinates on the measurement target.

Patterns

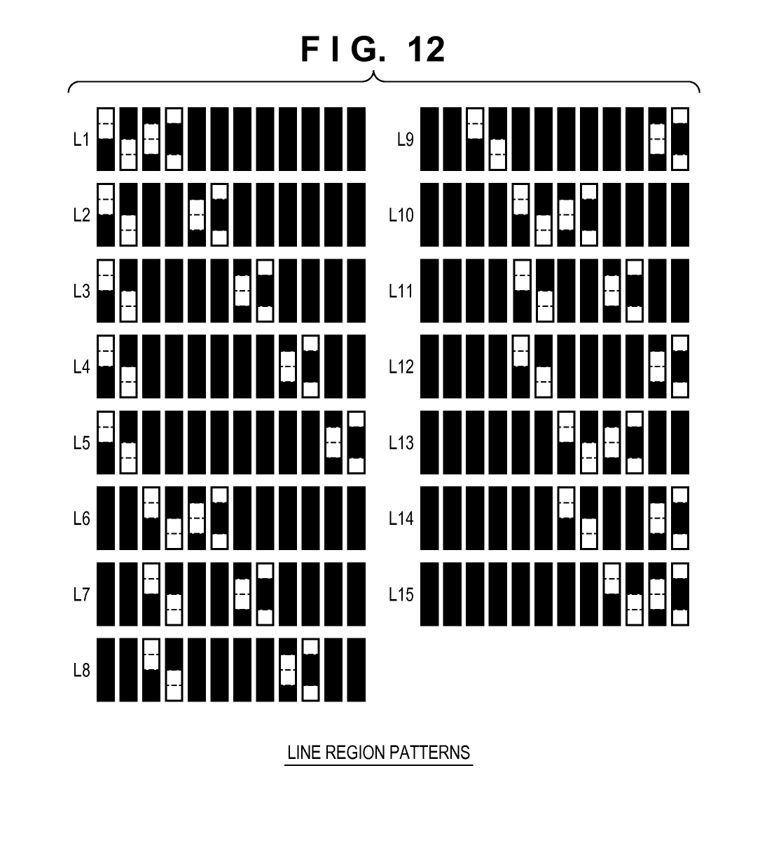

FIG. 12 shows an example of patterns generated by a projection pattern generation unit 202 according to the fourth embodiment. Unlike the patterns in the first to third embodiments in which only the projection order of dashed lines is changed, the patterns in the fourth embodiment are patterns in which the projection order, including the non-projection areas of dashed lines, is changed. The non-projection area is a dark portion parallel to a dashed line with the same width as that of the dashed line.

The patterns in the fourth embodiment are constituted by rearrangement of 2N dashed lines (projection areas) and M non-projection areas, that is, a total of 2N+M in the time series order in each line region. By utilizing this arrangement, a line region is discriminated. FIG. 12 shows an example of a time-series pattern for N=2 and M=8.

The order of four dashed lines each obtained by shifting a dashed line of a four-pixel cycle for one cycle pixel by pixel, and eight non-projection areas is changed. In line region patterns L1 to L15, segments in which the positions of the light portions completely coincide with each other do not exist. In other words, a combination of light and dark by a plurality of dashed lines and non-projection areas is different for each pixel in the patterns. For this reason, a total of 15 types of projection patterns can be discriminated from 12 images.

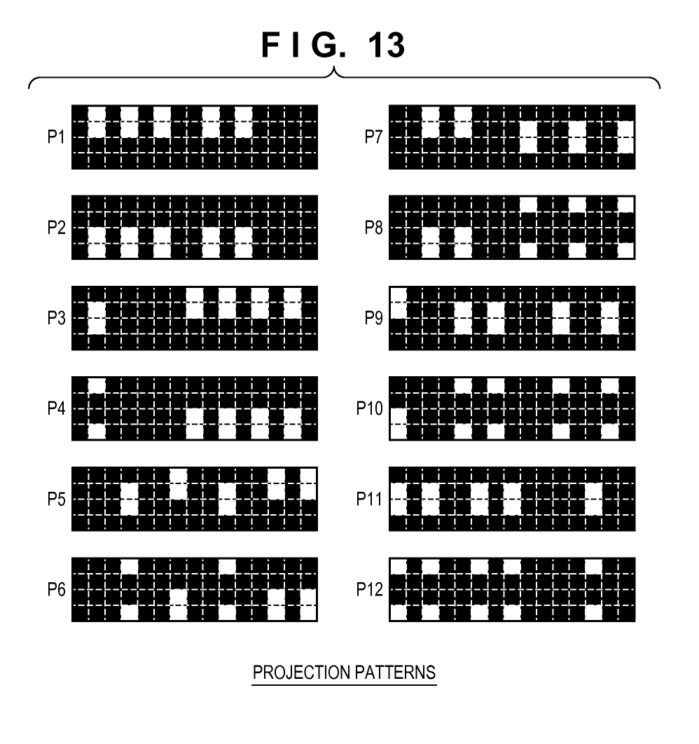

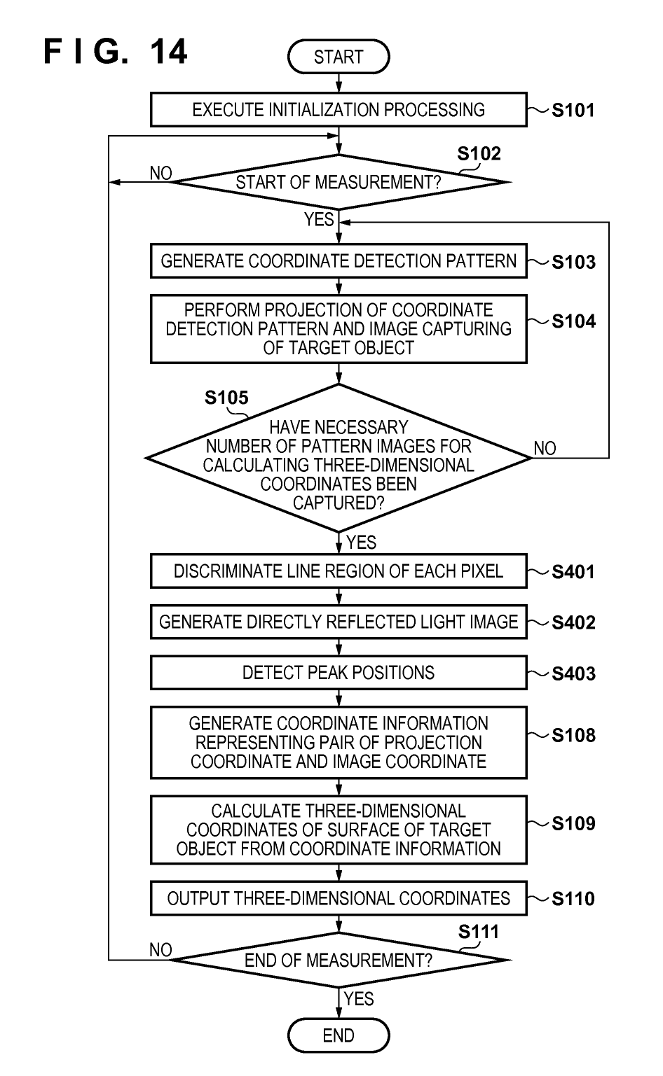

FIG. 13 shows projection patterns generated by arranging the patterns shown in FIG. 12 in the spatial direction. Each of projection patterns P1 to P12 is obtained by arranging 15 types of line region patterns in the lateral direction. The longitudinal direction is constituted by a minimum unit of four pixels of a dashed line for N=2. The arrangement order is L15, L1, L14, L2, L13, L5, L11, L9, L3, L6, L4, L7, L12, L8, and L10. A pattern to be actually projected is a pattern including a plurality of dashed lines obtained by repeating these projection patterns.

FIG. 13 shows a projection pattern in which line region patterns are arranged so that dashed lines to be projected are not adjacent to each other, in order to prevent degradation of the internal scattering component removal performance in each projection pattern. In other words, non-projection areas are arranged between a plurality of dashed lines in this projection pattern. However, the projection pattern determination method is not limited to this. For example, pixels of non-projection areas may always be interposed between line region patterns. When degradation of the internal scattering component removal performance is permitted, dashed lines may be simultaneously projected in adjacent line region patterns.

As described above, the numbers of pixels of the light and dark portions may be different, or the light and dark portions need not be repeated regularly. Multiple tones may be used instead of the binary of the light and dark portions, or encoding may be performed by the projection color.

Image Processing Unit

Processing of discriminating a line region based on the light and dark of a captured image and generating a directly reflected light image based on the discrimination result by an image processing unit 205 will be described.

A reflected light image generation unit 301 extracts two images in descending order of luminance from 12 time-series images in order to discriminate a line region to which each pixel to be processed belongs. For example, when two images having large luminances in a given pixel are the first and fourth images, it is detected that this pixel corresponds to the first segment of L1 shown in FIG. 12, and it is determined that this pixel belongs to the line region of L1.

However, for a pixel in which no dashed line has been projected, images larger in luminance than other time-series images may not be detected, or four large-luminance images may be detected under the influence of two dashed lines in a pixel between these dashed lines. Such a pixel exists at a position apart from the peak position of a line region where dashed lines are projected, and is not used as a measurement target point, thus need not undergo discrimination of a line region, and is subsequently handled as a pixel out of the processing target.

Next, the reflected light image generation unit 301 calculates a directly reflected light component for each pixel having undergone discrimination of a line region. First, the number of an image in which a dashed line pattern has been projected is extracted from a discriminated line region. For example, when a line region discriminated for a given pixel is L4 shown in FIG. 12, dashed line patterns are projected in the first, second, ninth, and 10th images. The maximum and minimum values of the pixel value of this pixel in these four images are obtained.

As described above, the maximum value in the four images can be regarded as both the observed reflected light component and internal scattering component, and the minimum value can be regarded as the internal scattering component itself. Hence, a value obtained by subtracting the minimum value from the maximum value is a directly reflected light component reflected by the surface of a target object 104. The reflected light image generation unit 301 removes the internal scattering component, and generates a directly reflected light image including only the directly reflected light component.

[Measurement Processing]

Measurement processing by a three-dimensional measurement apparatus 100 according to the fourth embodiment will be explained with reference to the flowchart of FIG. 14. Processes in steps S101 to S105 are the same as the processes in the first embodiment shown in FIG. 6, and a detailed description thereof will not be repeated.

Upon completion of capturing a necessary number of pattern images for calculating three-dimensional coordinates, the reflected light image generation unit 301 discriminates the line region of each pixel near a peak position (S401). A pixel in which no line region has been discriminated is excluded from targets of subsequent processing.

Then, the reflected light image generation unit 301 extracts, based on discriminated line regions, the numbers of images in which dashed line patterns have been projected to the target object 104. The reflected light image generation unit 301 calculates reflected light from these images, and generates a directly reflected light image (S402).

Based on the directly reflected light image, the peak position detection unit 402 detects the peak position of a line region where each dashed line has been projected (S403). The discrimination of the line region and the detection of the peak position are completed at this time, and the process advances to step S108. Processes in subsequent steps S108 to S111 are the same as those in the first embodiment shown in FIG. 6, and a detailed description thereof will not be repeated.

In this way, non-projection areas are added to time-series patterns to be projected to line regions, and arranged to generate time-series patterns. As a result, the number of line regions discriminable at once can be increased. For example, three line regions can be discriminated in every six captured images in the third embodiment, whereas 15 line regions can be discriminated in every 12 captured images in the fourth embodiment. The discrimination number of line regions is proportional to the number of measurement target points. If the number of captured images is the same, calculation of three-dimensional measurement points in a wider range becomes possible.

### Fifth Embodiment

Information processing according to the fifth embodiment of the present invention will be described below. In the fifth embodiment, the same reference numerals as those in the first to fourth embodiments denote the same parts, and a detailed description thereof will not be repeated.

In the fifth embodiment, as in the second embodiment, a space division pattern is projected to divide a measurement space including a target object 104 into a plurality of regions. Further, a coordinate detection pattern including a plurality of uniquely discriminable dashed lines is projected to the divided region. Accordingly, the influence of internal scattering generated in the target object 104 is removed, and the three-dimensional coordinates of the surface of the target object 104 are measured more quickly and precisely.

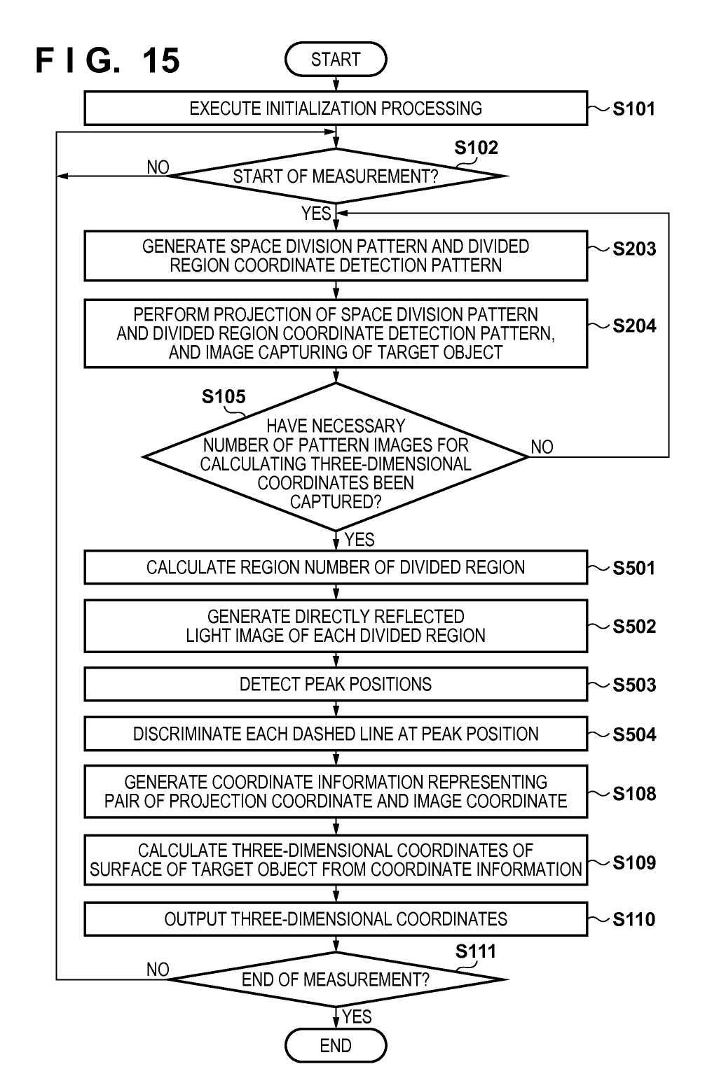

Measurement processing by a three-dimensional measurement apparatus 100 according to the fifth embodiment will be explained with reference to the flowchart of FIG. 15. Processes in steps S101, S102, S203, S204, and S105 are the same as the processes in the second embodiment shown in FIG. 9, and a detailed description thereof will not be repeated.

Upon completion of capturing a necessary number of pattern images for calculating three-dimensional coordinates, a reflected light image generation unit 301 calculates the region number of a divided region from an image in which a space division pattern has been projected to the target object 104 (S501), as in the second embodiment. Then, the reflected light image generation unit 301 generates the directly reflected light image of each divide region (S502).

Upon generating the directly reflected light image, a peak position detection unit 402 detects, based on the directly reflected light image of each divided region, the peak position of the line region where each dashed line has been projected (S503). Subsequently, a pattern light decoding unit 403 discriminates each dashed line at the peak position (S504).

Processes in subsequent steps S108 to S111 are the same as those in the second embodiment shown in FIG. 9, and a detailed description thereof will not be repeated.

As described above, a pattern including a plurality of discriminable dashed lines is projected to each spatially divided region, and the dashed lines are discriminated in each region. The influence of internal scattering generated in the target object 104 can be removed, and three-dimensional coordinates can be calculated more quickly and precisely. Although a combination of the third embodiment and the space division pattern has been described above, a combination of the fourth embodiment and the space division pattern is also possible and the same effects as those described above can be obtained.

### Modification of Embodiments

An example of using, as dashed line patterns, all patterns in which each dashed line is shifted pixel by pixel for one cycle in the longitudinal direction has been described. However, the number of pixels necessary to calculate a reflected light component can be reduced by increasing the shift amount to be more than one pixel. However, when the number of dashed line patterns is decreased, the number of discriminable line regions is also decreased, and the internal scattering component removal performance by the dashed line patterns may degrade. Thus, it is desirable to determine the shift amount in consideration of the image capturing count, the number of measurement target points, and the internal scattering component removal performance.

The fourth embodiment has explained an example in which the number of discriminable line regions is increased by adding non-projection areas to dashed line patterns. However, the present invention is not limited to this. Not only non-projection areas, but also lines including light and dark portions, such as a dashed line pattern, may be added. By adding such areas and lines, the number of discriminable line regions can be further increased. However, as the ratio of light portions in each coordinate detection pattern to be projected increases, the luminance contrast of the light and dark portions of an image to be captured drops, and light/dark binarization processing becomes difficult. In other words, it is desirable to add lines including light and dark portions so as to increase the number of discriminable line regions as long as satisfactory contrast can be maintained.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2014-092001 filed Apr. 25, 2014 which is hereby incorporated by reference herein in its entirety.

What is claimed is:

1. A measurement apparatus for measuring a three-dimensional shape of an object to be measured using a projection device which projects a pattern to measurement space, and an imaging device which captures the measurement space, the apparatus comprising:
an obtaining unit configured to obtain a plurality of captured images from the imaging device, wherein the plurality of captured images represent patterns projected in a time series by the projection device, each pattern comprises a plurality of dashed lines each of which has a predetermined width, a longitudinal direction of each dashed line is substantially perpendicular to a base line defined by a line segment connecting an optical center of the projection device and an optical center of the imaging device, and each dashed line repeats light and dark in the longitudinal direction;
a discrimination unit configured to discriminate the plurality of dashed lines based on combinations of the light and dark in the plurality of captured images;
a coordinate detection unit configured to detect correspondences between projected coordinates of the plurality of dashed lines and image coordinates of the plurality of dashed lines based on information regarding the patterns and a discrimination result of the plurality of dashed lines; and
a calculation unit configured to calculate the three-dimensional shape of the object based on the correspondences, and calibration data of the projection device and the imaging device.

2. The apparatus according to claim 1, wherein the patterns are generated by sequentially shifting the plurality of dashed lines to the longitudinal direction in the time series, and, in a voluntary pixel, the combinations of the light and dark in the plurality of dashed lines sequentially shifted in the time series are different from each other in the time series.

3. The apparatus according to claim 1, wherein a repetition of the light and dark has a predetermined period corresponding to a number of pixels, the patterns are generated by sequentially shifting the plurality of dashed lines in the time series, and each dashed line is shifted one period.

4. The apparatus according to claim 1, wherein a number of the dashed lines capable of discriminating by the discrimination unit depends on the period.

5. The apparatus according to claim 1, wherein the discrimination unit observes a value of pixel of interest in the time series, and discriminates the plurality of dashed lines based on a change of the value of pixel of interest.

6. The apparatus according to claim 1, further comprising a generation unit configured to generate a directly reflected light image indicating a light component reflected by a surface of the object from the plurality of captured images,
wherein the discrimination unit performs the discrimination using the directly reflected light image.

7. The apparatus according to claim 1, wherein the discrimination unit performs the discrimination using dashed line code information which indicates the combinations of the light and dark in the plurality of dashed lines.

8. The apparatus according to claim 1, wherein the coordinate detection unit performs the detection based on projection pattern information indicating projection positions of the plurality of dashed lines included in the patterns, and the discrimination result of the plurality of dashed lines.

9. The apparatus according to claim 1, wherein the patterns comprise a space division pattern for dividing the measurement space into a plurality of regions, and the discrimination unit performs the discrimination in each region.

10. The apparatus according to claim 1, further comprising a peak detection unit configured to detect peak positions in which a pixel value of each dashed line indicates a peak, in the plurality of captured images,
wherein the discrimination unit performs the discrimination in pixels corresponding to the peak positions.

11. The apparatus according to claim 1, wherein the patterns comprise non-projection areas, each of which has a width equal to the width of each dashed line and is parallel with the dashed line.

12. The apparatus according to claim 11, wherein each of the non-projection areas is disposed between the plurality of dashed lines.

13. The apparatus according to claim 11, wherein combinations of light and dark by the plurality of dashed lines and the non-projection areas are different for each pixel in the patterns.

14. A method of measuring a three-dimensional shape of an object to be measured using a projection device which projects a pattern to measurement space, and an imaging device which captures the measurement space, the method comprising:
using a processor to perform steps of:
obtaining a plurality of captured images from the imaging device, wherein the plurality of captured images represent patterns projected in a time series by the projection device, each pattern comprises a plurality of dashed lines each of which has a predetermined width, a longitudinal direction of each dashed line is substantially perpendicular to a base line defined by a line segment connecting an optical center of the projection device and an optical center of the imaging device, and each dashed line repeats light and dark in the longitudinal direction;
discriminating the plurality of dashed lines based on combinations of the light and dark in the plurality of captured images;
detecting correspondences between projected coordinates of the plurality of dashed lines and image coordinates of the plurality of dashed lines based on information regarding the patterns and a discrimination result of the plurality of dashed lines; and
calculating the three-dimensional shape of the object based on the correspondences, and calibration data of the projection device and the imaging device.

15. A non-transitory computer readable medium storing a computer-executable program for causing a computer to perform a method of measuring a three-dimensional shape of an object to be measured using a projection device which projects a pattern to measurement space, and an imaging device which captures the measurement space, the method comprising:
obtaining a plurality of captured images from the imaging device, wherein the plurality of captured images represent patterns projected in a time series by the projection device, each pattern comprises a plurality of dashed lines each of which has a predetermined width, a longitudinal direction of each dashed line is substantially perpendicular to a base line defined by a line segment connecting an optical center of the projection device and an optical center of the imaging device, and each dashed line repeats light and dark in the longitudinal direction;
discriminating the plurality of dashed lines based on combinations of the light and dark in the plurality of captured images;
detecting correspondences between projected coordinates of the plurality of dashed lines and image coordinates of the plurality of dashed lines based on information regarding the patterns and a discrimination result of the plurality of dashed lines; and
calculating the three-dimensional shape of the object based on the correspondences, and calibration data of the projection device and the imaging device.
